(19) United States
(12) Patent Application Publication
(10) Pub. No.: US 2008/0187624 A1
(43) Pub. Date: Aug. 7, 2008

(54) Wheyless Process for the Production of String Cheese

(76) Inventors: Richard Harold Lincourt, Mundelein, IL (US); Arlene Cheryl Clarkson, Chicago, IL (US)

Correspondence Address: FITCH EVEN TABIN & FLANNERY, 120 S. LASALLE STREET, SUITE 1600, CHICAGO, IL, 60603-3406, US

(21) Appl. No.: 12/025,531

(22) Filed: Feb. 4, 2008

Related U.S. Application Data
(63) Continuation of application No. 10/938,686, filed on Sep. 10, 2004, now abandoned.

(51) Int. Cl. A23C 9/12

(52) U.S. Cl. 426/39; 426/36

(57) ABSTRACT

The present invention provides a wheyless process for preparing natural mozzarella string cheese using dry dairy ingredients. This process enables the manufacture of string cheese from non-perishable or shelf-stable ingredients such as dried milk protein concentrate and anhydrous milkfat.

### RELATED APPLICATION

This application is a continuation of U.S. patent application Ser. No. 10/938,686, filed Sep. 10, 2004.

### FIELD OF THE INVENTION

The present invention generally relates to methods for preparing mozzarella string cheese. More specifically, the present invention relates to wheyless processes for preparing natural mozzarella string cheese and string cheese analogs from dried dairy and non-dairy ingredients.

### BACKGROUND OF THE INVENTION

Traditional manufacturing of mozzarella cheese for string cheese generally uses full or reduced-fat milk. The milk is treated with chymosin or similar enzymes, and then it is acidified with lactic acid bacterial cultures or vinegar to form curds and whey. In the traditional manufacture of mozzarella cheese that is generally used for the production of string cheese, the curd is separated from the whey, and then the curd is cooked and stretched in a hot water solution to yield the desirable mozzarella texture.

Traditional methods, while producing an excellent finished product, have the disadvantage of being relatively expensive and time consuming. Traditional methods utilize large quantities of fresh milk which requires cooling and storage facilities. In the traditional manufacture of mozzarella, the curd is formed and separated from the whey. Additional costs are incurred in separating the curd from the whey, and during this process, valuable fat and milk proteins are lost in the whey. Using traditional methods, it is then necessary to process the whey for conversion into other products or to treat it prior to disposal.

It is known in the prior art to produce a processed mozzarella cheese having some of the attributes of natural cheese; such processed cheese may be substituted for natural cheese in some applications. Processed mozzarella cheese can be made using conventional mozzarella cheese curd, a proteinaceous ingredient (e.g., casein, caseinates, and milk protein concentrates) and a fat source (e.g., butterfat, cream, or vegetable oil) cooked in the presence of significant levels of emulsifying salts (e.g., sodium phosphates, sodium citrates, and the like). However, such processed mozzarella cheese, in addition to compositional differences, does not have the desired textural or flavor attributes normally associated with natural mozzarella. Moreover, although the manufacture of processed mozzarella does not produce whey, the process utilizes traditional mozzarella curd which does require whey removal. Therefore, the processing costs associated with whey removal are not avoided.

The current invention provides a mozzarella string cheese with very similar textural, flavor, and compositional attributes as compared to conventionally prepared natural mozzarella string cheese. The mozzarella string cheese of the present invention is prepared using a process which utilizes dry dairy raw materials and avoids the costly refrigerated transportation and/or storage of fresh milk as well as the processing costs and losses associated with whey removal, cooking, and stretching.

### SUMMARY OF THE INVENTION

The present invention provides a wheyless process for preparing mozzarella string cheese from dry dairy ingredients.

In one embodiment (as generally illustrated in FIG. 1), the present invention provides a method for preparing mozzarella string cheese from dry dairy ingredients, the method comprising:

(1) mixing water and a dairy fat to form a first blend;

(2) adding a proteolytic enzyme to the first blend;

(3) adding a lactic acid-producing culture to the first blend to form a second blend;

(4) mixing a dry dairy ingredient with the second blend to form a cultured dairy blend, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;

(5) incubating the cultured dairy blend at a temperature and for a time sufficient to obtain a pH of about 4.8 to about 5.3;

(6) mechanically working and cooking the cultured dairy blend from step (5) in a cooker at a temperature of about 150 to about 175° F. and under relatively low shear conditions;

(7) extruding the dairy blend under relatively low shear conditions to form the mozzarella string cheese; and

(8) collecting the mozzarella string cheese,

wherein the process does not include the formation of whey, wherein the mozzarella string cheese does not contain significant levels of added emulsifying salts, and wherein the mozzarella string cheese has texture and organoleptic properties comparable to a natural mozzarella string cheese prepared in a conventional mozzarella process. Preferably the pH of the mozzarella string cheese is about 5.1 to about 5.3; if necessary, an edible acid may be added (preferably during the working and cooking step) to obtain the desired final pH. The proteolytic enzyme is preferably chymosin or another animal and/or a microbial or plant-derived enzyme having similar activity. Preferably, the dairy fat is cream, liquid or anhydrous milkfat, butter, or mixtures thereof; generally the dairy fat selected is based on prevailing market conditions and availability. Other optional ingredients such as salt, stabilizers, gums, preservatives, supplements, condiments, and the like may be incorporated into the string cheese; such optional ingredients are preferably added prior to, or during, the working and cooking step.

In another embodiment (as generally illustrated in FIG. 2), the present invention provides a method for preparing mozzarella string cheese from dry dairy ingredients, the method comprising:

(1) mixing water and a dairy fat to form a first blend;

(2) adding a lactic acid-producing culture to the first blend to form a second blend;

(3) adding a proteolytic enzyme to the second blend;

(4) mixing a dry dairy ingredient with the second blend to form a cultured dairy blend, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;

(5) incubating the cultured dairy blend at a temperature and for a time sufficient to obtain a pH of about 4.8 to about 5.3;

(6) mechanically working and cooking the cultured dairy blend from step (5) in a cooker at a temperature of about 150 to about 175° F. and under relatively low shear conditions;

(7) extruding the dairy blend under relatively low shear conditions to form the mozzarella string cheese; and

(8) collecting the mozzarella string cheese,

wherein the process does not include the formation of whey, wherein the mozzarella string cheese does not contain significant levels of added emulsifying salts, and wherein the mozzarella string cheese has texture and organoleptic properties comparable to a natural mozzarella string cheese prepared in a conventional mozzarella process. Preferably the pH of the mozzarella string cheese is about 5.1 to about 5.3. The proteolytic enzyme is preferably chymosin or another animal and/or a microbial or plant-derived enzyme having similar activity. Preferably, the dairy fat is cream, liquid or anhydrous milkfat, butter, or mixtures thereof; generally the dairy fat selected is based on prevailing market conditions and availability. Other optional ingredients such as salt, stabilizers, gums, preservatives, supplements, condiments, and the like may be incorporated into the string cheese; such optional ingredients are preferably added prior to, or during, the working and cooking step.

In another embodiment (as generally illustrated in FIG. 3), the present invention provides a method for preparing mozzarella cheese from dry dairy ingredients, the method comprising:

(1) mixing water and a dairy fat to form a blend;

(2) adding a proteolytic enzyme to the blend;

(3) adding an edible acid to the blend to adjust the pH to about 4.8 to about 5.3;

(4) mixing a dry dairy ingredient with the blend to form a dairy blend containing kappa-casein, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;

(5) holding the dairy blend from step (4) at a temperature of about 2 to about 50° C. for at least about 10 minutes;

(6) mechanically working and cooking the dairy blend from step (5) in a cooker at a temperature of about 150 to about 175° F. and under relatively low shear conditions;

(7) extruding the worked and cooked dairy blend under relatively low shear conditions to form the mozzarella string cheese; and

(8) collecting the mozzarella string cheese,

wherein the process does not include the formation of whey, wherein the mozzarella string cheese does not contain significant levels of added emulsifying salts, and wherein the mozzarella string cheese has texture and organoleptic properties comparable to a natural mozzarella string cheese prepared in a conventional mozzarella process. Generally, the dairy blend from step (4) is held at about 2 to about 50° C. for at least about 10 minutes and preferably about 10 minutes to about 4 hours. Although not wishing to be limited by theory, it is believed that during this step (4), the kappa-casein is partially hydrolyzed. Preferably the final pH of the mozzarella string cheese is about 5.1 to about 5.3. The proteolytic enzyme is preferably chymosin or another animal and/or a microbial or plant-derived enzyme having similar activity. Preferably, the dairy fat is cream, liquid or anhydrous milkfat, butter, or mixtures thereof; generally the dairy fat selected is based on prevailing market conditions and availability. Other optional ingredients such as salt, stabilizers, gums, preservatives, supplements, condiments, and the like may be incorporated into the string cheese; such optional ingredients are preferably added prior to, or during, the working and cooking step.

In another embodiment (as generally illustrated in FIG. 4), the present invention provides a method for preparing mozzarella string cheese from dry dairy ingredients, the method comprising:

(1) mixing a dairy fat and a proteolytic enzyme to form a first mixture;

(2) mixing an edible acid (e.g., lactic acid) and water form a second mixture;

(3) combining the first mixture and the second mixture to form a blend;

(4) mixing a dry dairy ingredient with the blend to form an acidified dairy blend, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;

(5) holding the acidified dairy blend at a temperature and for a time sufficient to obtain a pH of about 4.8 to about 5.3;

(6) mechanically working and cooking the cultured dairy blend from step (5) in a cooker at a temperature of about 150 to about 175° F. and under relatively low shear conditions;

(7) extruding the dairy blend under relatively low shear conditions to form the mozzarella string cheese; and

(8) collecting the mozzarella string cheese,

wherein the process does not include the formation of whey, wherein the mozzarella string cheese does not contain significant levels of added emulsifying salts, and wherein the mozzarella string cheese has texture and organoleptic properties comparable to a natural mozzarella string cheese prepared in a conventional mozzarella process. Preferably the final pH of the mozzarella string cheese is about 5.1 to about 5.3. The proteolytic enzyme is preferably chymosin or another animal and/or a microbial or plant-derived enzyme having similar activity. Preferably, the dairy fat is cream, liquid or anhydrous milkfat, butter, or mixtures thereof; generally the dairy fat selected is based on prevailing market conditions and availability. Other optional ingredients such as salt, stabilizers, gums, preservatives, supplements, condiments, and the like may be incorporated into the string cheese; such optional ingredients are preferably added prior to, or during, the working and cooking step.

A principal advantage of the current invention is that it enables the manufacture of cheese from non-perishable or shelf-stable ingredients such as dried milk protein concentrate and anhydrous milkfat. This enables greater flexibility in the location of cheese manufacturing facilities as handling and/or transporting large quantities of fresh milk is not required. Also, in utilizing such a process, the need for refrigerated storage of the fresh milk would be minimal.

The dry dairy ingredients used in the present invention comprise milk protein concentrates and blends of milk protein concentrates with up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof. More preferably, the dry dairy ingredient used in the present invention consists essentially of about 80 to 100 percent milk protein concentrate and 0 to about 20 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof. An especially preferred dry dairy ingredient for use in the present invention is about 80 to about 90 percent milk protein concentrate and about 10 to about 20 percent rennet casein. The dry ingredients of the present invention can be used as dry powders or can be reconstituted with water prior to use. In an important aspect of the invention, the milk protein concentrate should have a solubility of greater than about 50 percent and a whey protein content of less than about 15 percent in order to obtain mozzarella cheese with acceptable texture and flavor. For purposes of this invention, a whey protein content of a specified value refers to the fraction of total crude protein rather than the total composition; in other words, a whey protein content of less than about 15 percent means that, of the total protein content of the composition, less than 15 percent consists of whey protein. Preferably, the milk protein concentrate has an average particle size of less than about 250 microns. Preferably, the second dry dairy ingredient also has a relatively high solubility (i.e., about 50 percent or higher) and/or a relatively small particle size (i.e., less than about 100 microns).

One important aspect of the present invention is the addition of a proteolytic enzyme, which modifies the proteins so that a fibrous, stringy aggregation of the protein occurs during subsequent processing. Animal-, plant-, or microbial-derived proteolytic enzymes can be used to obtain the attributes of conventionally made string cheese (i.e., peelable fibers, firmness, and appearance). Suitable animal-derived proteolytic enzymes are well-known in the cheesemaking art and include, for example chymosin (veal rennet, SKW Biosystems, Waukesha, Wis.) and pepsin (SKW Biosystems, Waukesha, Wis.). Suitable microbial proteolytic enzymes include Chymax 2X (Chr. Hansen, Milwaukee, Wis.), Maxiren (Gist Brocades, Delft, Netherlands), and Fromase (Gist Brocades, Delft, Netherlands). Suitable plant derived enzymes which may be used include bromelain and papain (Enzyme Development Corp., NY). These enzymes are generally added at about 0.01 to about 0.2 percent. In a particularly preferred embodiment, the proteolytic enzyme used is chymosin.

### BRIEF DESCRIPTION OF THE DRAWINGS

FIG. 1 is a flowchart illustrating an embodiment of the present invention using a lactic acid culture.

FIG. 2 is a flowchart illustrating another embodiment of the present invention using a lactic acid culture.

FIG. 3 is a flowchart illustrating another embodiment of the present invention using an edible acid.

FIG. 4 is a flowchart illustrating another embodiment of the present invention using lactic acid.

### DETAILED DESCRIPTION

The present invention relates to a method for producing a mozzarella string cheese using highly soluble milk protein concentrates. More particularly, the milk protein concentrate should have a solubility of at least about 50 percent and a whey protein content of less than about 15 percent. Milk protein concentrates lacking these characteristics generally produce substandard cheese products (i.e., the resulting cheese will generally have a grainy or gritty texture and will lack the desirable texture characteristic of mozzarella cheese). A particular advantage of the invention is that the process may be carried out using dry dairy ingredients.

As noted, the milk protein concentrate used in the present invention should have a solubility of more than about 50 percent, and preferably more than 80 percent, and a whey protein content less than about 15 percent. For purposes of this invention, solubility can be measured using conventional techniques such as, for example, the method described in Moore et al., “Collaborative Study to Develop a Standardized Food Protein Solubility Procedure,” J. Food Sci., 50, 1715 (1985), which is incorporated herein by reference. Typical milk protein concentrates are made by membrane ultrafiltration of milk to partially remove water, lactose, and salts. Diafiltration with water may be used to further reduce the lactose and salt levels. Essentially all of the casein and whey proteins (and fat, if present) are retained in the retentate by a membrane with a 10,000 dalton molecular weight cut-off. For use in the present invention, a preferred retentate should contain casein and whey protein in the ratio of no more than about 85:15. Preferably, such retentate can be obtained using microfiltration membranes (e.g., ceramic membranes having about 0.1 micron pore diameter). Such membranes, depending on pH, temperature, and other operating conditions, permit whey proteins to pass through the membrane while retaining most or essentially all of the casein; thus, retentates enriched in casein and depleted in whey protein can be obtained. The retentate may be used in the wet state to make cheese, or it may be dried to yield a shelf-stable powder which can be rehydrated for later use.

The milk protein concentrates of the present invention should have whey protein levels less than about 15 percent, preferably less than 12 percent, and more preferably 0 to about 10 percent. In other words, less than about 15 percent of the total protein in the milk protein concentrate should be whey protein. Such milk protein concentrates may be produced by microfiltration or by a combination of ultrafiltration and microfiltration. Other methods which could be used to provide such milk protein concentrates include, for example, size exclusion chromatography, ion exchange chromatography, electrophoresis, and high pressure carbon dioxide treatment (see, e.g., Tomasula et al., J. Food Sci., 65, 227 (2000); generally, however, such methods are not currently available in sufficient scale to justify their use in industrial cheese-making operations. Without being bound by theory, it is believed that whey protein above about 15 percent interferes with the alignment of casein molecules into the fibers required for good mozzarella texture.

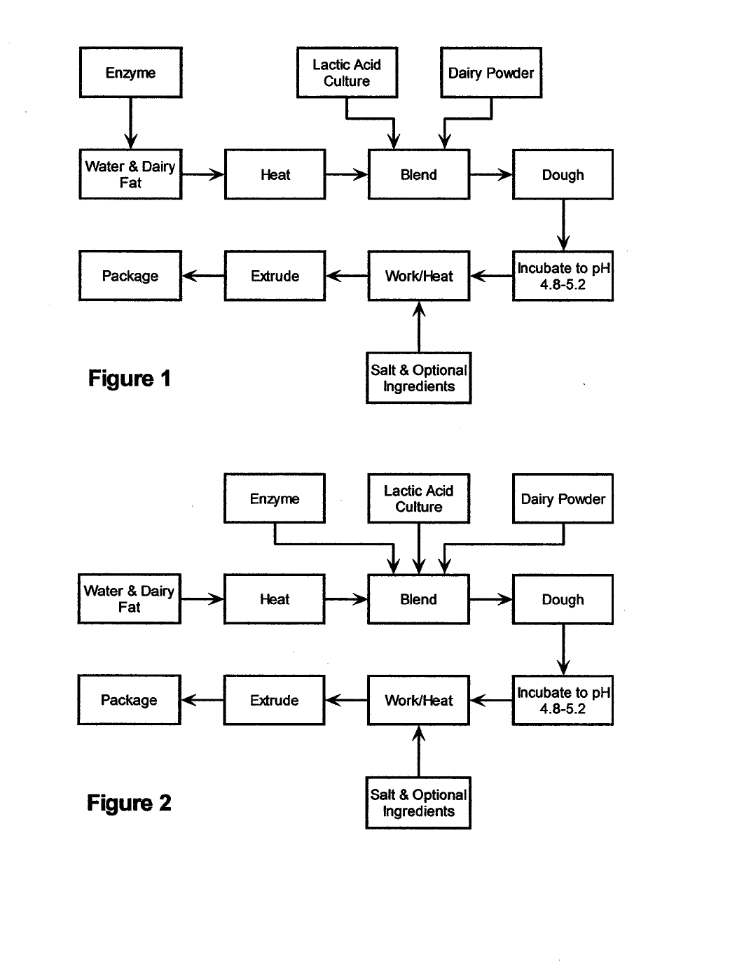

FIGS. 1 through 4 illustrate different embodiments of the present invention. These embodiments mainly differ in the acidifying or coagulating agent used and in the points in the process in which the enzyme and dry dairy powder are added.

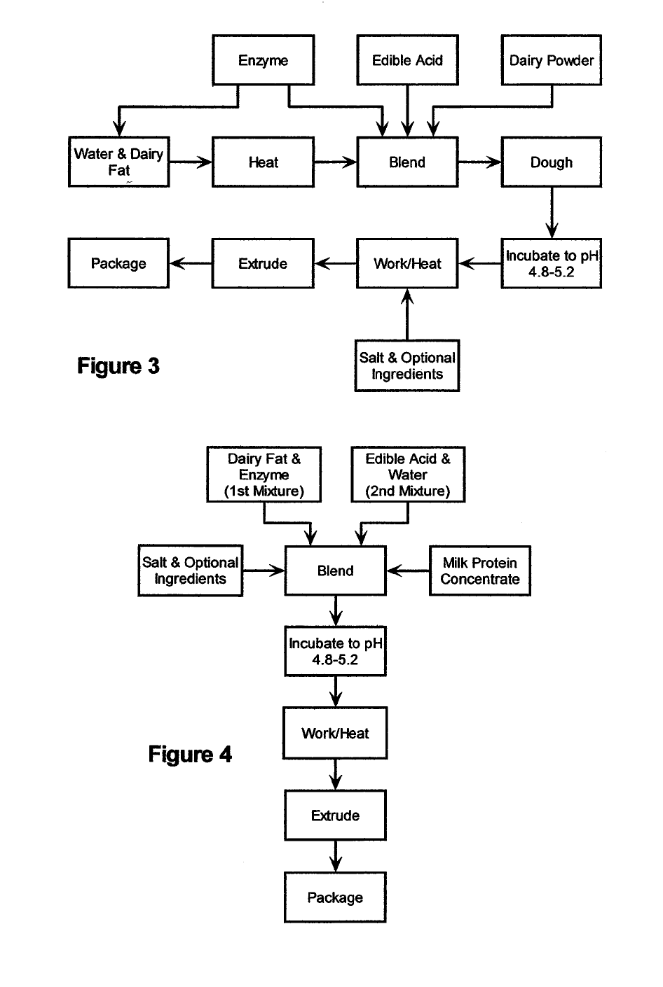

The processes illustrated in FIGS. 1 and 2 use a lactic acid-producing culture as the acidifying or coagulating agent. The processes illustrated in FIGS. 3 and 4 use an edible acid as the acidifying agent. The embodiments in FIGS. 1 and 2 differ mainly in the point in the process in which the proteolytic enzyme is added. In the process shown in FIG. 1, the enzyme is added to the dairy fat; in the process shown in FIG. 2, the enzyme is added to the blend.

The mozzarella string cheese of this invention does not contain significant levels of added emulsifying salts. In other words, emulsifying salts, if added at all, are only added at relatively low levels (i.e., generally at levels of about 0.5 percent or less); such low levels are significantly below the levels normally associated with processed cheese. Such emulsifying salts, if added, are present at levels sufficient to act as processing aids. Generally, it is preferred that emulsifying salts are not added since they tend to produce textural and melt properties characteristics similar to processed cheese rather than the desired natural mozzarella string cheese.

In the embodiment illustrated in FIG. 1, a lactic acid-producing culture is used as the acidifying or coagulating agent and the dry dairy powder is added to the blend to create a dough or dairy blend. A homogeneous mixture of water and a dairy fat, typically containing about 25 to about 60 percent milkfat and about 40 to about 75 percent water, is prepared at a temperature of about 60 to about 110° F. in a suitable mixing vessel. The final fat content of the full fat cheese is normally about 20 to about 30 percent. Low and reduced fat cheeses would be about 12 to about 15 percent fat. A fat source used could be a cream (>18 percent fat) or other dairy fat, including anhydrous milkfat (100 percent). When blended with the formula water, the fat and water “blend” could be as low as about 15 percent and as high as about 50 percent fat. For no-, low-, or reduced-fat varieties, the homogenous mixture of water and a dairy fat will typically contain 0 to about 18 percent fat. The source of dairy fat can be commercial pasteurized cream, anhydrous milkfat, butter, or mixtures thereof; generally the dairy fat selected is based on prevailing market conditions and availability. If desired, this mixture may be further stabilized by passing through a homogenizer at a pressure of about 200 psi or higher. If desired, a portion of the dairy fat could be replaced or supplemented with vegetable fat (e.g., coconut oil, palm kernel oil, soy oil, and the like).

A proteolytic enzyme ( animal-, plant-, or microbial-derived) or a combination of such enzymes is added to the lactic-acid producing culture in order to modify the textural characteristics of the resulting mozzarella string cheese. Suitable animal-derived proteolytic enzymes are well-known in the cheesemaking art and include, for example chymosin (veal rennet, SKW Biosystems, Waukesha, Wis.) and pepsin (SKW Biosystems, Waukesha, Wis.). Suitable microbial proteolytic enzymes include Chymax 2X (Chr. Hansen, Milwaukee, Wis.), Maxiren (Gist Brocades, Delft, Netherlands), and Fromase (Gist Brocades, Delft, Netherlands). Suitable plant derived enzymes which may be used include bromelain and papain (Enzyme Development Corp., NY). These enzymes, if used, are generally added at about 0.01 to about 0.2 percent.

A lactic acid-producing culture or mixture of lactic acid-producing cultures is added at a concentration of about 0.01 to about 5 percent (preferably about 0.1 to about 2 percent) with mixing. Suitable lactic acid-producing cultures are well known in the cheese-making art and include, for example, mesophilic cultures such as Lactococcus lactis and Lactococcus cremoris and thermophilic cultures such as Streptococcus thermophilus, Lactobacillus helveticus, and Lactobacillus bulgaricus. In addition to the use of bulk cultures, both mesophilic and thermophilic cultures may be conveniently added as “direct vat set” (DVS) cultures since they are more concentrated than the bulk cultures. Such DVS cultures are typically added at the rate of about 0.01 to about 0.2 percent. Examples of suitable DVS cultures include, for example, thermophilic cultures such as Yofast 15, Stc4, Stc7, IT1 and LH32, and the like; and mesophilic cultures such as R603 and CHN322 (all from Chr. Hansen, Inc., Milwaukee, Wis.).

The dry dairy ingredient or powder is then added with stirring at a level of about 25 to about 55 percent, preferably about 30 to about 40 percent; stirring is continued until the powder is uniformly wetted to form a plastic “dough.” The dry dairy ingredient generally contains about 80 to 100 percent milk protein concentrate and 0 to about 20 percent of one or more other dry proteinaceous dairy ingredients. The milk protein concentrate should have a solubility of at least about 50 percent and a whey protein content of less than about 15 percent. Suitable commercially available milk protein concentrates include, for example, Nutrilac CH7813 (ARLA Foods, Skanderborgvej, Denmark), Promilk 852B (Ingredia Dairy Ingredients, Arras Cedex, France), and Kerry RD4003-73B (Kerry Food Ingredients, Beloit, Wis.).

By way of illustration, a suitable milk protein concentrate for use in the present invention could be made using the following general procedure. Skim milk is heated to about 120° F. and acidified with food-grade hydrochloric acid to a pH of about 5.8. The acidified milk is microfiltered using a 0.1 micron ceramic membrane (Tetra-Pak, Vernon Hills, Ill.) with continuous recycle at about 120° F. until the total solids in the retentate has increased to about 25 percent. The mixture is then diafiltered using water at about 120° F. until the lactose content of the retentate is below about 15 percent, and preferably below about 2.5 percent, of total solids. Preferably, food-grade sodium hydroxide is added to the diafiltration water in sufficient quantity to adjust the pH of the retentate after diafiltration to about 6.5. While the initial skim milk contains casein and whey protein in the ratio of about 80:20, expressed as percent of total protein, the retentate has a casein/whey protein ratio of greater than about 85:15 and preferably greater than about 90:10. Although the liquid retentate can be used, it is generally preferred that it is spray dried using conventional techniques to provide a dry powder (e.g., moisture content of about 4 percent) with a solubility greater than about 50 percent and preferably greater than about 80 percent.

The second dry dairy ingredient is preferably selected from the group consisting of whey protein concentrate, whey protein isolate, calcium caseinate, sodium caseinate, rennet casein, acid casein, nonfat dry milk, and mixtures thereof. Preferred blends of milk protein concentrate and the second dry dairy ingredient include, for example, a blend of about 80 percent Nutrilac CH7813 and about 20 percent calcium caseinate (e.g., Alanate 380 from New Zealand Milk Products, Santa Rosa, Calif.), a blend of about 80 percent Nutrilac CH7813 and about 20 percent nonfat dry milk, and a blend of about 93.5 percent Nutrilac CH7813 and about 6.5 percent whey protein concentrate (e.g., AMP800 from AMPC Inc., Ames, Iowa).

The dough or dairy blend is held at a temperature and for a time sufficient to allow the pH to drop to about 4.8 to about 5.3, preferably about 5.1 to about 5.3. The temperature required depends, in part, on the specific acidifying agent used. Generally, the temperature should be below about 130° F. More specifically, for example, if the acidifying agent is a thermophilic lactic acid-producing culture, a temperature of about 95 to about 120° F., and preferably about 104 to about 110° F., is acceptable. If the acidifying agent is a mesophilic lactic acid-producing culture, a temperature of about 65 to about 95° F., and preferably about 72 to about 86° F., would be acceptable. Typically, using these acidifying agents and temperatures, the pH will reach the desired level in about 3 to about 5 hours. The pH drop is due to the action of the culture which converts lactose to lactic acid (plus flavor components).

Once the pH reaches the desired level, the dough or dairy blend is mechanically worked and heated to achieve the desired texture. A typical device that can be used is a “laydown cooker” (e.g., Damrow, Fond du Lac, Wis.) having a single auger or twin-screw augers for mechanically working the cheese and steam jets for directly heating the cheese. Generally, the shear should be relatively low since excessive shear (i.e., about 100 sec⁻¹ or higher) can impair the texture of the resulting cheese and even, in some cases, result in phase separation. Shear should, however, be sufficient to provide good mixing. Shear serves several important functions during the cooking step. For example, it tends to form and align casein fibers to form the desirable fibrous structure associated with mozzarella cheese. Shear also assists in dispersing and evenly distributing various components such as fat, moisture, salt, supplements, other optional ingredients, and the like throughout the cheese mass. Using either indirect or direct (i.e., steam injection) heating, shear also assists in heat transfer. Excessive shear, however, may have detrimental effects, including as noted texture impairment and/or phase separation. It is important, therefore, to adjust the shear during cooking to promote such desirable effects while minimizing the potentially detrimental effects.

The amount of desirable shear will vary depending on a number of factors, including for example, the composition of the cheese, the cooking conditions, and the cooker used. One of ordinary skill in the art can empirically determine appropriate shear levels for a given composition and make the appropriate adjustments. Generally the shear should be relatively low (i.e., less than about 100 sec⁻¹, preferably less than about 10 sec⁻¹) since excessive shear can impair the texture of the resulting cheese. Generally, shear values of less than about 3 sec⁻¹ are preferred for compositions containing insignificant levels of non-proteinaceous hydrocolloids and/or relatively low levels of total protein (i.e., less than about 20 percent). For example, the auger speed of a conventional pilot-plant scale laydown cooker with a capacity of about 40 lbs will generally be less than about 125 rpm, and more preferably about 50 to 60 rpm, to avoid excessive shear; of course, other sized cookers may require different operating conditions to avoid such excessive shear.

Salt, as well as optional ingredients, can be added to the cheese at the blend stage or in the cooker. Salt is normally added in the amount of about 1 to about 2.5 percent, and more preferably at about 1.5 to about 2 percent. If appropriate, additional water may be added to the cooker to adjust the moisture content of the final cheese. If direct steam heating is used, the resulting condensate generally increases the moisture content of the cheese by about 3 to about 6 percent; this added moisture must be taken into account in achieving the desired final moisture content.

Optional ingredients can be incorporated into the string cheese products so long as they do not interfere with the production of and/or the organoleptic properties of the string cheese. Such optional ingredients, which may be added to the blender or cooker, include, for example, hydrocolloid gums (including, but not limited to, sodium carboxymethylcellulose, sodium alginate, konjac gum, carrageenan, xanthan gum, modified food starch, and the like) at about 0.1 to about 1 percent; flavors, both natural and compounded, at about 0.05 to about 2 percent; colorants at about 0.05 to about 2 percent; preservatives or anti-microbials (e.g., sorbic acid, potassium sorbate, benzoic acid, other food-grade acids, salt, essential oils, natural anti-microbial substances (e.g., nisin, nystatin, cultured milk, cultured whey), and the like) at about 0.05 to about 0.25 percent; minerals, vitamins, and other supplements (e.g., calcium, vitamin A, and the like) at about 0.01 to about 1 percent. Hydrocolloids, if used, are best pre-mixed with other ingredients and added at the blender stage. A calcium-fortified mozzarella cheese, for example, can be prepared using the addition of tricalcium phosphate, calcium phosphate, calcium carbonate, calcium sulfate, calcium citrate, and the like as well as mixtures thereof; and a soy-protein fortified cheese could be prepared using the addition of soy protein isolate. Similarly, if desired, food ingredients and condiments such as vegetables, meats, spices, and the like can be readily incorporated into the mozzarella string cheese of the present invention. Such food ingredients and condiments, if added, have a relatively small average particle size (i.e., less than about 0.25 inches in their largest dimension).

The cheese is cooked to about 150 to about 175° F., and more preferably to about 155 to about 160° F., with continuous mixing and working. The cheese is held at this temperature for about 1 to about 4 minutes, preferably about 2 minutes, to achieve the desired texture. Textural properties can be measured using conventional techniques and equipment (e.g., Texture Analyzer from Stable Micro Systems, London, England). The resulting mozzarella cheese is then extruded under low shear conditions to form the mozzarella string cheese. One example of an extruder that can be used according to the present invention is a low-shear twin-screw extruder (Supreme Stainless Steel Fabricating Company, Columbus, Wis.); using a speed of about 5 to about 30 rpm in such equipment should provide sufficiently low shear conditions. The string cheese can then be collected and packaged using conventional techniques. For example, the mozzarella string cheese can be packaged using a mechanical pumping or extrusion device (e.g., “Polar Pump” (Polar Process Inc., Plattsville, Ont.) or Handtmann (Handtmann Inc., Buffalo Grove, Ill.)) in order to further work the cheese, modify its texture, and extrude it into various desired shapes (e.g., rods, balls, shreds, animal-shapes, stars, letters, and the like). The pH of the final product is preferably in the range of about 5.1 to about 5.3.

A modified embodiment of the present invention is shown in FIG. 2. This embodiment also uses a lactic-acid producing culture to achieve the desired pH. In this embodiment, however, the proteolytic enzyme is added to the blend containing the dairy fat and the lactic acid culture. Otherwise, the process is carried out in a manner similar to that described above for FIG. 1.

Another embodiment of the present invention is shown in FIG. 3. This embodiment relies upon the addition of an edible acid, rather than a lactic-acid producing culture, to achieve the desired pH. In this embodiment, the enzyme can be added to the dairy fat (similar to the process shown in FIG. 1 ) or to the blend (similar to the process shown in FIG. 2).

A homogeneous mixture of water and a dairy fat, typically containing about 25 to about 60 percent milkfat and about 40 to about 75 percent water, is prepared at a temperature of about 60 to about 110° F. in a suitable mixing vessel. The final fat content of the full fat cheese is normally be about 20 to about 30 percent. Low and reduced fat cheeses would be about 12 to about 15 percent fat. A fat source used could be a cream (>18 percent fat) or other dairy fat, including anhydrous milkfat (100 percent). When blended with the formula water, the fat and water “blend” could be as low as about 15 percent and as high as about 50 percent fat. For no-, low-, or reduced-fat varieties, the homogenous mixture of water and a dairy fat will typically contain 0 to about 18 percent fat. The source of dairy fat can be commercial pasteurized cream, anhydrous milkfat, butter, or mixtures thereof; generally the dairy fat selected is based on prevailing market conditions and availability. If desired, this mixture may be further stabilized by passing through a homogenizer at a pressure of about 200 psi or higher. If desired, a portion of the dairy fat could be replaced or supplemented with vegetable fat (e.g., coconut oil, palm kernel oil, peanut oil, soy oil, and the like).

The dry dairy powder, the acid and the proteolytic enzyme are mixed with the dairy fat to form the blend. The dry dairy ingredient or powder is then added with stirring at a level of about 25 to about 55 percent, preferably about 30 to about 40 percent; stirring is continued until the powder is uniformly wetted to form a plastic “dough.” The dry dairy ingredient generally contains about 80 to 100 percent milk protein concentrate and 0 to about 20 percent of one or more other dry proteinaceous dairy ingredients, both as described above. The milk protein concentrate should have a solubility of at least about 50 percent and a whey protein content of less than about 15 percent. The second dry dairy ingredient is preferably selected from the group consisting of whey protein concentrate, whey protein isolate, calcium caseinate, sodium caseinate, rennet casein, acid casein, nonfat dry milk, and mixtures thereof.

An animal-, plant-, or microbial-derived proteolytic enzyme or combination of enzymes is added to the blend in order to modify the textural characteristics of the resulting mozzarella string cheese. Suitable animal-derived proteolytic enzymes are well-known in the cheesemaking art and include, for example chymosin (veal rennet, SKW Biosystems, Waukesha, Wis.) and pepsin (SKW Biosystems, Waukesha, Wis.). Suitable microbial proteolytic enzymes include Chymax 2X (Chr. Hansen, Milwaukee, Wis.), Maxiren (Gist Brocades, Delft, Netherlands), and Fromase (Gist Brocades, Delft, Netherlands). Suitable plant derived enzymes which may be used include bromelain and papain (Enzyme Development Corp., NY). These enzymes, if used, are generally added at about 0.01 to 0.2 percent.

An edible acid is added to the blend in an amount sufficient to achieve a pH of about 4.8 to about 5.3. Suitable edible acids include, for example, acetic acid, citric acid, lactic acid, glucono-delta-lactone, phosphoric acid, vinegar, and the like. Vinegar and lactic acid are the preferred edible acids.

Then the dough or dairy blend is mechanically worked and heated to achieve the desired texture. A typical device that can be used is a “laydown cooker” (e.g., Damrow, Fond du Lac, Wis.) having a single auger or twin-screw augers for mechanically working the cheese and steam jets for directly heating the cheese. Generally and as noted above, the shear should be relatively low (i.e., less than about 100 sec⁻¹, preferably less than about 10 sec⁻¹) since excessive shear can impair the texture of the resulting cheese. Generally, shear values of less than about 3 sec⁻¹ are preferred for compositions containing insignificant levels of non-proteinaceous hydrocolloids and/or relatively low levels of total protein (i.e., less than about 20 percent). For example, the auger speed of a conventional pilot-plant scale laydown cooker with a capacity of about 40 lbs will generally be less than about 125 rpm, and more preferably about 50 to 60 rpm, to avoid excessive shear; of course, other sized cookers may require different operating conditions to avoid such excessive shear.

Salt, as well as optional ingredients, can be added to the cheese in the blender or cooker as described above with respect to the method illustrated in FIG. 1. Likewise, the resulting cheese can be cooked and packaged as described above with respect to the method illustrated in FIG. 1.

Another embodiment of the present invention is shown in FIG. 4. This embodiment also relies upon the addition of an edible acid, rather than a lactic-acid producing culture, to achieve the desired pH. In this embodiment, the dairy fat and the enzyme are combined to form a first mixture. Acid and water are combined to form a second mixture. The first and second mixtures are then combined to form a blend. Milk protein concentrate is added to the blend as well as salt any other desired optional ingredients. The blend is mixed under relatively low shear conditions until it reaches a pH of about 4.8 to about 5.3. Once the desired pH is reached, the blend is cooked and extruded to form mozzarella string cheese as described in Example 1.

The lactose content of conventionally prepared natural mozzarella cheese is traditionally fairy low; typically less than about 0.5 g per one ounce serving. As such, many conventionally prepared mozzarella cheeses can be labeled as “lactose free” and safely consumed by individuals with an intolerance to lactose. Additionally, low lactose levels in such cheeses provide functional benefits such as reduced browning in baking applications. String cheese produced by the methods of the present invention may be formulated to have similarly low levels of lactose by utilizing dairy ingredients which have been processed to remove, or reduce the levels of, lactose. Alternatively, lactose levels of the cheeses produced by the methods of this invention may also be reduced by culturing using lactase enzymes. For example, a yeast lactase (Valley Research Inc., South Bend, Ind.) can be added at a level of about 0.0001 to about 0.1 percent along with the dairy culture in order to reduce lactose levels. If used, such lactase enzymes would be incorporated into the composition before the cooking step; generally, it may be easier to disperse the lactase enzymes into the composition before the dough is formed.

Definitions. The definitions of a number of terms and phrases used in the present application are provided. As used herein, “dairy fat” relates to cream, liquid or anhydrous milkfat, butter, or mixtures thereof; a portion of the dairy fat can be replaced or supplemented with vegetable fats (e.g., coconut oil, palm kernel oil, peanut oil, soy oil, and the like).

As used herein, “milk protein concentrate” relates to milk protein concentrates prepared using membrane ultrafiltration and/or microfiltration of skim (or whole) milk to remove water, lactose, and salts. Diafiltration with water may be used to further reduce lactose and salts. Similar concentrating techniques can also be used if desired. Essentially all of the casein and whey proteins (and fat, if present) are retained in the retentate by a ultrafiltration membrane with a 10,000 molecular weight cut-off. A microfiltration membrane with a pore size of about 0.1 microns will permit, under appropriate conditions, retention of most or essentially all of the casein in the retentate and passage of some of the whey protein into the permeate. For use in the present invention, such preferred retentate should contain casein and whey protein in the ratio of no more than about 85 to about 15. Therefore, microfiltration or a combination of microfiltration and ultrafiltration are preferred in the present invention. The retentate may be used in the wet state to make cheese, or it may be spray-dried to yield a shelf-stable powder which can be rehydrated for later use.

As used herein, “whey protein concentrate” relates to the proteins which are concentrated from whey (i.e., dairy liquid obtained as a supernatant of the curds when milk or a product containing milk components are curded to produce a semisolid cheese curd). Whey protein is generally understood to include principally the globular proteins β-lactoglobulin and α-lactalbumin; it also includes a significantly lower concentration of immunoglobulin and other globulins. Generally, such whey protein concentrates contain about 30 to about 70 percent protein (solid basis). Whey protein concentrate may be prepared from whey by processes such as ultrafiltration plus diafiltration wherein water and non-proteinaceous components such as lactose and minerals are removed. Alternatively, whey protein concentrates may be prepared from fluid whole or skim milk by processes such as microfiltration which permit the separation of caseins from whey proteins without the formation of a coagulum. As used herein, “whey protein isolates” are produced from whey in a manner similar to a whey protein concentrate but generally have a protein content of about 75 to about 95 percent (solid basis). For purposes of this invention, a whey protein content of a specified value refers to the fraction of total crude protein rather than the total composition; in other words, a whey protein content of less than about 15 percent means that, of the total protein content of the composition, less than 15 percent consists of whey protein.

As used herein, “relatively low shear” relates to shear values in the cooker or in the forming device (e.g., extruder) which can achieve the desired texture of the resulting cheese. A typical cooker that can be used is a “laydown cooker” (e.g., Damrow, Fond du Lac, Wis.) having a single auger or twin-screw augers for mechanically working the cheese and steam jets for directly heating the cheese. Generally, the shear should be relatively low (i.e., less than about 100 sec⁻¹, preferably less than about 10 sec⁻¹) since excessive shear can impair the texture of the resulting cheese. Generally, shear values of less than about 3 sec⁻¹ are preferred for compositions containing insignificant levels of non-proteinaceous hydrocolloids and/or relatively low levels of total protein (i.e., less than about 20 percent). For example, the auger speed of a conventional pilot-plant scale laydown cooker with a capacity of about 40 lbs will generally be less than about 125 rpm, and more preferably about 50 to 60 rpm, to avoid excessive shear; of course, other sized cookers may require different operating conditions to avoid such excessive shear.

As used herein, “hydrocolloid gum” relates to any substance that can disperse in water to form a viscous, mucilaginous mass. Hydrocolloid gums are often used in food processing to stabilize emulsions, or as a thickener. The gum may be extracted from seeds (e.g., guar gum, locust, quince, psyllium), sap or exudates (gum arabic, karaya, tragacanth, ghatti, bassora or hog gum chariots, mesquite, anguao) and seaweeds (agar, kelp, alginate, Irish moss) or they may be made from starch or cellulose (dextrins, methyl cellulose, carboxymethyl cellulose, and the like) or they may be synthetic, such as vinyl polymers.

As used herein, “preservative” relates to substances capable of retarding or arresting the deterioration of food. Suitable preservatives include, for example, sorbic acid, potassium sorbate, benzoic acid, other food-grade acids, salt, essential oils, natural anti-microbial substances (e.g., nisin, nystatin, cultured milk, cultured whey), and the like.

As used herein, “supplement” relates to essential dietary factors such as vitamins, minerals, amino acids, and the like.

As used herein, “condiment” relates to ingredients added to flavor food such as vegetables, meats, seasonings, spices, natural or artificial flavors, and the like.

The following examples are included to illustrate the invention and not to limit it. Unless otherwise indicated, all percentages and ratios are by weight. All references cited herein are incorporated by reference in their entireties.

### Example 1

Recombinant chymosin (0.005 lbs; Hansen's Chymax) was added to cream (about 44% milkfat; about 18 lbs) to produce a first mixture. Lactic acid (88%; about 0.8 lbs) was added to water to produce approximately 13 lbs of a second mixture. The two mixtures were combined to form a blend and added to a horizontal mixer with a paddle-bladed agitator (Marion model 1101 mixer, Rapid Machinery Co., Marion, Iowa) operated at approximately 50 rpm. Non-fat dry milk (about 2.5 lbs) and a calcium and whey protein-depleted milk protein concentrate (about 15 lbs) was added to the blend. The blend was mixed at a temperature of about 72 to about 74° F. for about 10 minutes, at which time the pH was about 5.2. The thoroughly mixed blend was then placed in a laydown cooker equipped with a single auger mixer. The blend was heated rapidly via direct steam injection to a temperature of 155° F. while the auger revolved at a speed of 124 rpm. The molten mass was transferred to a low-shear twin-screw extruder (Supreme Stainless Steel Fabricating Company, Columbus, Wis.). The mass was cooled to about 134 to about 145° F. and extruded (auger speed of about 26 rpm) through a tapered nozzle as a cheese “cylinder” of about 9/16 inch diameter. The extruded cheese was cut into approximately 5 to 6 inch sections and placed in a 20% salt solution for about 30 minutes. After removing from the salt bath, the cheese was chilled below 45° F., where it remained until firm and well chilled. The chilled cheese was drained and packaged in plastic film. The resulting mozzarella string cheese product, which had a pH of about 5.2, was firm and could be peeled into long, fibrous strips or “strings” typical of string cheese.

### Example 2

Chymosin (0.03 lbs; Hansen's Chymax) was added to cream (40% milkfat; about 24.8 lbs) to produce a first mixture. Lactic acid (88%; about 0.9 lbs) was added to water (about 2 lbs) to produce a second mixture. The two mixtures were combined and then added to a horizontal mixer with a paddle-bladed agitator (Marion model 1101 mixer, Rapid Machinery Co., Marion, Iowa) operated at about 50 rpm. A calcium and whey protein-depleted milk protein concentrate (about 14 lbs) and salt (about 0.8 lbs) were added to the blend and mixed at a temperature of about 72 to 74° F. for about 10 minutes, at which time the pH was about 5.15. The thoroughly mixed mass was then placed in a laydown cooker equipped with a single auger mixer operated at about 124 rpm and then heated rapidly via direct steam injection to about 160° F. The molten mass was transferred to a low-shear twin-screw extruder (Supreme Stainless Steel Fabricating Company, Columbus, Wis.). After cooling to about 134 to 145° F., the mass was extruded (auger speed of about 26 rpm through a tapered nozzle to form a cheese “cylinder” of about 9/16 inch diameter. The cylinder of cheese was cut into about 5 to 6 inch sections and placed in a 2% salt solution chilled below 45° F., where it remained until firm and well chilled. The chilled cheese was drained and packaged in plastic film. The resulting mozzarella string cheese product, which had a pH of about 5.15, was firm and could be peeled into long, fibrous strips or “strings” typical of string cheese.

### Example 3

In this comparative example, the same ingredients and procedures were used as in Example 2 except that no chymosin was included in the formulation. The resulting product, which had a pH of about 5.15, was firm but lacked the fibrous strips typical of string cheese.

### Example 4

Chymosin (0.005 lbs; Hansen's Chymax) was added to cream (40% milkfat; about 19 lbs) to produce a first mixture. Lactic acid (88%; about 0.8 lbs) was added to water (about 6 lbs) to produce a second mixture. The two mixtures were combined and added to a Hobart mixer with a paddle-bladed agitator (Hobart model M 802U) operated at about 80 rpm. A calcium and whey protein-depleted milk protein concentrate (about 12 lbs) and salt (about 0.8 lbs) were added and the mixture mixed at about 72 to 74° F. for about 20 minutes, at which time the pH was 5.2. The thoroughly mixed mass was then placed in a laydown cooker equipped with a single auger mixer. It was heated rapidly via direct steam injection to about 165° F. using an auger speed of about 124 rpm. The molten mass was then stretched repeatedly by hand to determine if it had developed a fibrous texture. The stretched mass was placed in a 5% salt solution chilled below 45° F., where it remained until firm and well chilled. The chilled cheese was drained. The resulting string cheese product, which had a pH of about 5.2, was firm and could be peeled into long, fibrous strips or “strings” typical of string cheese.

### Example 5

In this comparative example, the same ingredients and procedures were used as in Example 4 except that the amount of lactic acid was varied. In the first instance, the amount of lactic acid was reduced to about 0.6 lbs. The resulting product from the laydown cooker had a pH of about 5.4, was soft and developed only a weak fibrous texture. In the second instance, the amount of lactic acid was increased to about 0.9 lbs. The resulting product from the laydown cooker had a pH of less than 5.0, was curdy and syneresed and did not develop a fibrous texture.

### Example 6

Recombinant chymosin (10 g; Hansen's Chymax) was added to cream (about 40% milkfat; about 20.5 lbs) to produce a first mixture. Lactic acid (88%; about 0.9 lbs) was added to water to produce approximately 7 lbs of a second mixture. The two mixtures were combined to form a blend and added to a horizontal mixer with a paddle-bladed agitator (Marion model 1101 mixer, Rapid Machinery Co., Marion, Iowa) operated at approximately 50 rpm. A calcium and whey protein-depleted milk protein concentrate (about 14 lbs) was added to the blend. The blend was mixed at a temperature of about 72 to about 74° F. for about 10 minutes, at which time the pH was about 5.0. The thoroughly mixed blend was then placed in a laydown cooker equipped with a single auger mixer. The blend was heated rapidly via direct steam injection to a temperature of 160° F. while the auger revolved at a speed of 124 rpm. The molten mass was transferred to a low-shear twin-screw extruder (Supreme Stainless Steel Fabricating Company, Columbus, Wis.). The mass was cooled to about 134 to about 145° F. and extruded (auger speed of about 26 rpm) through a tapered nozzle as a cheese “cylinder” of about 9/16 inch diameter. The extruded cheese was cut into approximately 5 to 6 inch sections and placed in a 2% salt solution chilled below 45° F., where it remained until firm and well chilled. The chilled cheese was drained and packaged in plastic film. The resulting mozzarella string cheese product, which had a pH of about 5.0, was firm and could be peeled into long, fibrous strips or “strings” typical of string cheese.

What is claimed is:

1. A method for preparing mozzarella string cheese from dry dairy ingredients, the method comprising:
(1) mixing water and a dairy fat to form a first blend;
(2) adding a proteolytic enzyme to the first blend;
(3) adding a lactic acid-producing culture to the first blend to form a second blend;
(4) mixing a dry dairy ingredient with the second blend to form a cultured dairy blend, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;
(5) incubating the cultured dairy blend at a temperature and for a time sufficient to obtain a pH of about 4.8 to about 5.3;
(6) mechanically working and cooking the cultured dairy blend from step (5) in a cooker at a temperature of about 150 to about 175° F. and under relatively low shear conditions;
(7) forming the dairy blend under relatively low shear conditions to form the mozzarella string cheese; and
(8) collecting the mozzarella string cheese,
wherein the process does not include the formation of whey, wherein the mozzarella string cheese does not contain significant levels of added emulsifying salts, and wherein the mozzarella string cheese has texture and organoleptic properties comparable to a natural mozzarella string cheese prepared in a conventional mozzarella process.

2. The method of claim 1, wherein the mozzarella string cheese has a final pH of about 5.0 to about 5.3.

3. The method of claim 1, wherein the incubation temperature is about 95 to about 120° F. if the lactic acid-producing culture is thermophilic or about 65 to about 95° F. if the lactic acid-producing culture is mesophilic; wherein the dry dairy ingredient comprises the milk protein concentrate or the blend of the milk protein concentrate and up to about 20 percent of the second dry dairy ingredient; and wherein the mozzarella string cheese is formed by extruding the dairy blend under relatively low shear conditions.

4. The method of claim 3, wherein the dry dairy ingredient is the milk protein concentrate.

5. The method of claim 3, wherein the dry dairy ingredient consists essentially of about 80 to 100 percent the milk protein concentrate and 0 to about 20 percent of the second dry dairy ingredient.

6. The method of claim 1, wherein the mozzarella cheese from step (6) is cooled to about 120 to about 140° F. and then formed into a desired shape prior to being collected.

7. The method of claim 3, wherein the mozzarella cheese from step (6) is cooled to about 120 to about 140° F. and then formed into a desired shape prior to being collected.

8. The method of claim 1, wherein a lactase enzyme is included in the cultured dairy blend to reduce the lactose level of the mozzarella string cheese.

9. The method of claim 3, wherein a lactase enzyme is included in the cultured dairy blend to reduce the lactose level of the mozzarella string cheese.

10. The method of claim 8, where the lactase enzyme is present at about 0.0001 to about 0.1 percent.

11. The method of claim 9, where the lactase enzyme is present at about 0.0001 to about 0.1 percent.

12. The method of claim 1, wherein the proteolytic enzyme is chymosin.

13. The method of claim 3, wherein the proteolytic enzyme is chymosin.

14. A method for preparing mozzarella string cheese from dry dairy ingredients, the method comprising:
(1) mixing water and a dairy fat to form a first blend;
(2) adding a lactic acid-producing culture to the first blend to form a second blend;
(3) adding a proteolytic enzyme to the second blend;
(4) mixing a dry dairy ingredient with the second blend to form a cultured dairy blend, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;
(5) incubating the cultured dairy blend at a temperature and for a time sufficient to obtain a pH of about 4.8 to about 5.3;
(6) mechanically working and cooking the cultured dairy blend from step (5) in a cooker at a temperature of about 150 to about 175° F. and under relatively low shear conditions;
(7) forming the dairy blend under relatively low shear conditions to form the mozzarella string cheese; and
(8) collecting the mozzarella string cheese,
wherein the process does not include the formation of whey, wherein the mozzarella string cheese does not contain significant levels of added emulsifying salts, and wherein the mozzarella string cheese has texture and organoleptic properties comparable to a natural mozzarella string cheese prepared in a conventional mozzarella process.

15. A method for preparing mozzarella string cheese from dry dairy ingredients, the method comprising:
(1) mixing water and a dairy fat to form a blend;
(2) adding a proteolytic enzyme to the blend;
(3) adding an edible acid to the blend in an amount sufficient to adjust the pH to about 4.8 to about 5.3;
(4) mixing a dry dairy ingredient with the blend to form a dairy blend, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;
(5) mechanically working and cooking the dairy blend from step (4) in a cooker at a temperature of about 150 to about 175° F. and under relatively low shear conditions;
(6) extruding the dairy blend under relatively low shear conditions to form the mozzarella string cheese; and
(7) collecting the mozzarella string cheese,
wherein the process does not include the formation of whey, wherein the mozzarella string cheese does not contain significant levels of added emulsifying salts, and wherein the mozzarella string cheese has texture and organoleptic properties comparable to a natural mozzarella string cheese prepared in a conventional mozzarella process.

16. The method of claim 15, wherein the dry dairy ingredient is the milk protein concentrate.

17. The method of claim 15, wherein the dry dairy ingredient consists essentially of about 80 to 100 percent the milk protein concentrate and 0 to about 20 percent of the second dry dairy ingredient.

18. The method of claim 15, wherein a lactase enzyme is included in the blend to reduce the lactose level of the mozzarella string cheese.

19. The method of claim 18, where the lactase enzyme is present at about 0.0001 to about 0.1 percent.

20. The method of claim 15, wherein the edible acid is vinegar or lactic acid.

21. A method for preparing mozzarella string cheese from dry dairy ingredients, the method comprising:
(1) mixing a dairy fat and a proteolytic enzyme to form a first mixture;
(2) mixing an edible acid and water form a second mixture;
(3) combining the first mixture and the second mixture to form a blend;
(4) mixing a dry dairy ingredient with the blend to form an acidified dairy blend, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;
(5) incubating the acidified dairy blend at a temperature and for a time sufficient to obtain a pH of about 4.8 to about 5.3;
(6) mechanically working and cooking the cultured dairy blend from step (5) in a cooker at a temperature of about 150 to about 175° F. and under relatively low shear conditions;
(7) forming the dairy blend under relatively low shear conditions to form the mozzarella string cheese; and
(8) collecting the mozzarella string cheese,
wherein the process does not include the formation of whey, wherein the mozzarella string cheese has a final pH of about 5 to about 5.3, wherein the mozzarella string cheese does not contain significant levels of added emulsifying salts, and wherein the mozzarella string cheese has texture and organoleptic properties comparable to a natural mozzarella string cheese prepared in a conventional mozzarella process.

22. A method for preparing mozzarella string cheese from dry dairy ingredients, the method comprising:
(1) mixing a dairy fat and a proteolytic enzyme to form a first mixture;
(2) mixing lactic acid and water form a second mixture;
(3) combining the first mixture and the second mixture to form a blend;
(4) mixing a dry dairy ingredient with the blend to form an acidified dairy blend, wherein the dry dairy ingredient comprises a milk protein concentrate or a blend of the milk protein concentrate and up to about 50 percent of a second dry dairy ingredient selected from the group consisting of whey protein concentrate, whey protein isolate, calcium caseinate, sodium caseinate, rennet casein, acid casein, nonfat dry milk, proteinaceous dairy material, and mixtures thereof, and wherein the milk protein concentrate has a solubility of greater than about 50 percent and a whey protein content of less than about 15 percent;
(5) holding the acidified dairy blend at a temperature and for a time sufficient to obtain a pH of about 4.8 to about 5.3;
(6) mechanically working and cooking the cultured dairy blend from step (5) in a cooker at a temperature of about 150 to about 175° F. and under relatively low shear conditions;
(7) extruding the dairy blend under relatively low shear conditions to form the mozzarella string cheese; and
(8) collecting the mozzarella string cheese,
wherein the process does not include the formation of whey, wherein the mozzarella string cheese does not contain significant levels of added emulsifying salts, wherein the mozzarella string cheese has a final pH of about 5.0 to about 5.3, and wherein the mozzarella string cheese has texture and organoleptic properties comparable to a natural mozzarella string cheese prepared in a conventional mozzarella process.
